(19) United States
(12) Patent Application Publication
(10) Pub. No.: US 2026/0004300 A1
(43) Pub. Date: Jan. 1, 2026

(54) TECHNIQUES FOR DETECTING UNDESIRABLE BATCH TRANSACTIONS

(71) Applicant: THE HUNTINGTON NATIONAL BANK, Columbus, OH (US)

(72) Inventors: Michael Kim, Plain City, OH (US); Brian Long, Athens, OH (US)

(21) Appl. No.: 18/759,315

(22) Filed: Jun. 28, 2024

(51) Int. Cl. G06Q 20/40; G06N 20/00; G06Q 20/02

(52) U.S. Cl. CPC G06Q 20/4016; G06N 20/00; G06Q 20/023

(57) ABSTRACT

Techniques are described herein for detecting undesirable batch transactions. A machine-learning model that has been trained to determine a likelihood that a given batch transaction is fraudulent may be obtained. The machine-learning model may be trained with a supervised learning algorithm and a training data set example of the training data set comprising a corresponding hash value generated from one or more data fields of at least one batch transaction header and a label indicating whether the training data set example is associated with a fraudulent batch transaction. The method may include generating a hash value based at least in part on providing a set of data field values of one or more batch transaction headers to a hashing algorithm as input. The method may include determining that the batch transaction is fraudulent based at least in part on output received from the machine-learning model.

### BACKGROUND

Bank fraud has typically involved using illegal means to obtain money, property, financial assets, or similar. In some situations, fraud can involve falsified or otherwise illicit transaction data. In a computer-based electronic network for processing transaction data, an automated clearing house “ACH” network may be used in domestic low value and/or high value transactions between participating organizations. ACH networks are designed to process batches of credits, debits, and various other transactions which may include hundreds to hundreds of thousands of transactions per batch per day. Detecting fraudulent activity, or other undesirable transactions, within these batches containing thousands of transactions every day can be a time consuming, data intensive, and complex.

### BRIEF SUMMARY OF THE INVENTION

Techniques are provided for fraud detection for batch transactions. Various embodiments are described herein, including methods, systems, non-transitory computer-readable storage media storing programs, code, or instructions executable by one or more processors, and the like.

One embodiment is directed to a computer-implemented method for detecting fraud in an automated clearing house (ACH) batch. The method may comprise obtaining, by a computing device, a machine-learning model that may be trained to determine a likelihood that a given batch transaction may be fraudulent. The machine-learning model may be trained with a supervised learning algorithm and a training data set, a training data set example of the training data set which may include a corresponding hash value that may generated from one or more data fields of at least one batch transaction header and a label that may indicate whether the training data set example is associated with a fraudulent batch transaction. The method may include receiving a batch transaction including one or more batch transaction headers and may generate a hash value based at least in part on providing a set of data field values of the one or more batch transaction headers to a hashing algorithm as input. The method may include providing the hash value as input data to the machine-learning model and determining that the batch transaction may be fraudulent based at least in part on output received from the machine-learning model. In some embodiments, the method may include performing one or more operations based at least in part on determining that the batch transaction is fraudulent.

In some embodiments, the batch transaction may be associated with an automated clearing house network.

In some embodiments, the method may include generating the training data set based at least in part on obtaining batch transaction instances that are known to be fraudulent or legitimate and generating a respective hash value from a respective set of batch transaction headers of the batch transaction instances. In some embodiments, the method may include labeling a batch transaction instance of the batch transaction instances with a respective label indicating that the batch transaction instance is fraudulent or legitimate and training the machine-learning model with the supervised learning algorithm and the training data set.

In some embodiments, the method may include concatenating the set of data field values of the one or more batch transaction headers to a text string and providing the set of data field values of the one or more batch transaction headers to the hashing algorithm as the input may include providing the text string to the hashing algorithm as the input.

In some embodiments, the set of data field values of the one or more batch transaction headers may correspond to a plurality of data fields selected from a file header record and a batch header record of the batch transaction.

In some embodiments, the set of data field values of the one or more batch transaction headers may include two or more data field values corresponding to an originating entity routing number, a receiving entity routing number, an originating entity name, a receiving entity name, a file creation date, a file creation time stamp, a transaction type, an originator identifier, a batch descriptor, or an effective entry date.

In some embodiments, the set of data field values of the one or more batch transaction headers may be combined according to a specified order prior to being provided to the hashing algorithm.

In some embodiments, a fraud detection device comprises one or more processors and one or more memories storing computer-executable instructions that, when executed by the one or more processors, causes the one or more processors to perform the method(s) disclosed herein.

In some embodiments, the processor(s) may obtain a machine-learning model that may be trained to determine a likelihood that a given check is fraudulent. The machine-learning model may be trained with a supervised learning algorithm and a training data set, a training data set example of the training data set that may include a corresponding hash value generated from one or more data fields of at least one batch transaction header and a label indicating whether the training data set example is associated with a fraudulent batch transaction. The processor(s) may receive a batch transaction that may include one or more batch transaction headers and generate a hash value based at least in part on providing a set of data field values of the one or more batch transaction headers to a hashing algorithm as input. The processor(s) may provide the hash value as input data to the machine-learning model and may determine that the batch transaction is fraudulent based at least in part on output received from the machine-learning model and perform one or more operations based at least in part on determining that the batch transaction is fraudulent.

In some embodiments, the batch transaction is associated with an automated clearing house network.

In some embodiments, the processor(s) may generate the training data set based at least in part on obtaining batch transaction instances that are known to be fraudulent or legitimate and generate a respective hash value from a respective set of batch transaction headers of the batch transaction instances. The processor may label a batch transaction instance of the batch transaction instances with a respective label indicating that the batch transaction instance is fraudulent or legitimate and train the machine-learning model with the supervised learning algorithm and the training data set.

In some embodiments, the processor(s) may concatenate the set of data field values of the one or more batch transaction headers to a text string and may provide the set of data field values of the one or more batch transaction headers to the hashing algorithm as the input causes the one or more processors to provide the text string to the hashing algorithm as the input.

In some embodiments, the set of data field values of the one or more batch transaction headers corresponds to a plurality of data fields selected from a file header record and a batch header record of the batch transaction.

In some embodiments, the set of data field values of the one or more batch transaction headers may include two or more data field values corresponding to an originating entity routing number, a receiving entity routing number, an originating entity name, a receiving entity name, a file creation date, a file creation time stamp, a transaction type, an originator identifier, a batch descriptor, or an effective entry date.

In some embodiments, the set of data field values of the one or more batch transaction headers are combined according to a specified order prior to being provided to the hashing algorithm.

In some embodiments, a non-transitory computer-readable storage medium storing computer-executable instructions that, when executed with one or more processors of a computing device, causes the computing device to perform the method(s) disclosed herein.

### BRIEF DESCRIPTION OF THE DRAWINGS

Various embodiments in accordance with the present disclosure will be described with reference to the drawings, in which:

FIG. 1 is an example flow for performing fraud detection of an Automated Clearing House (ACH) batch, in accordance with at least one embodiment;

FIG. 2 is an example block diagram illustrating techniques for generating a hash value from ACH header data, in accordance with at least one embodiment;

FIG. 3 illustrates a flow for an example method for training a machine-learning model, in accordance with at least one embodiment;

FIG. 4 is a block diagram illustrating an example system including a detection engine, in accordance with at least one embodiment;

FIG. 5 is a schematic diagram of an example computer architecture for the detection engine, including a plurality of modules that may perform functions in accordance with at least one embodiment;

FIG. 6 is a block diagram illustrating an example method for determining that a batch transaction is fraudulent, in accordance with at least one embodiment; and

FIG. 7 is a block diagram illustrating an example method for determining that a batch transaction is undesirable, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Techniques are provided for detecting fraud and/or other undesirable transactions at a batch transaction level. Institutions and consumers participate in transactions across the world and use computer networks and established financial networks to provide payments and/or receive payments for various reasons (e.g., payroll, routine payments, etc.). A batch transaction may refer to a collection of individual transactions that are to be processed as a unit within a network such as an Automated Clearing House (ACH) network. All of the data within the batch transaction is typically well defined by file headers, company names and types, and specific records to ensure that each transaction within the batch file is directed to the correct accounts.

As discussed previously, conventional batch transaction files may include hundreds of thousands of transactions where each transaction includes specific information such as which party is receiving the payment and which party is making the payment along with identifiers such as customer identification numbers, bank identification numbers, or similar. With a large number of transactions, detecting fraud and/or other undesirable anomalies/transactions becomes more complex. In addition, batch transactions typically have processing deadlines which must be adhered to in order for businesses and individuals to make timely payments and/or receive payments on time. Convention fraud detection systems such as risk scoring (e.g., a new user participating in the ACH network using an unknown account) may not be able to process all transactions in a timely manner due to the complexity of analyzing each of the hundreds of fields per transaction in the thousands of batch transactions. In addition, traditional fraud detection systems may apply averages over the thousands of transaction which may lead to some fraudulent activity being overlooked as “slipping” through the cracks by not deviating from the average by a certain amount for a certain transaction identifier (e.g., how much the transaction is worth).

The disclosed techniques disclosed herein provide improvements to detecting fraud and/or other undesirable transactions in batch transactions. Unlike conventional techniques which use overly complex techniques to analyze individual transactions, the detection engine as discussed in embodiments herein provides a significant technical improvement in simplifying the detection of fraud by detecting fraud at a batch transaction level. Any suitable number of data fields of the ACH header data may be used to generate a string, which is then provided to a hashing algorithm as input, resulting in a substantially smaller hash value that uniquely represents the combination of ACH header data fields. Hashing data has several advantages including reducing overall memory required to store the data, converting complex data into simpler formats, and due to the reduced overall memory requirements, provides case of processing since there are fewer data points to process. The hash value may be labeled (e.g., manually) as being “fraudulent” or “legitimate” and used as a training data example to train a machine-learning model to identify hash values generated from new ACH header data instances as being fraudulent or legitimate. Using hash values to train the model instead of the data fields provides a performance benefit as the hash values, being smaller, are able to be processed by the model faster than if the data fields were used.

For example, the detection engine may obtain an ACH batch transaction which includes any suitable number of batches, each batch having ACH header data corresponding to that batch of transactions. The detection engine may select any suitable combination of data field values of ACH header data and convert those values into a text string. For example, if the ACH header data included a bank name (e.g., “ABC Bank”) and a routing number (e.g., “23142151”), that data may be combined/concatenated into a text string (e.g., “ABC Bank 23142151”, “23142151 ABC Bank” and passed to a hashing algorithm as input. The resultant value (e.g., “49f6a2alsu82kd”) generated by the hashing algorithm may convert the text string to a fewer number of alphanumeric characters. Hashing data has several advantages including reducing overall memory required to store the data, converting complex data into simpler formats, and due to the reduced overall memory requirements, provides case of processing since there are fewer data points to process.

A detection model may be trained with the training data set using any suitable supervised learning algorithm. The training data set may include any suitable number of hashed ACH header data examples, each example being labeled. By way of example, in some embodiments, the examples may be labeled as “fraudulent” or “legitimate”. As another example, the examples may be labeled as “desirable” or “undesirable.” In other embodiments, the examples may be labeled as “normal” and “anomalous.” While some of the examples provided herein focus on detecting fraud, in particular, it should be appreciated that other undesirable and/or anomalous transactions may be detected using the disclosed techniques, not necessary only fraudulent transactions. When a new ACH batch transaction is received, any suitable portion of the ACH batch header data may be hashed to produce a hash value, which may then be provided to the trained detection model as input. The output provided by the detection model may be used to determine that the ACH batch is fraudulent or legitimate.

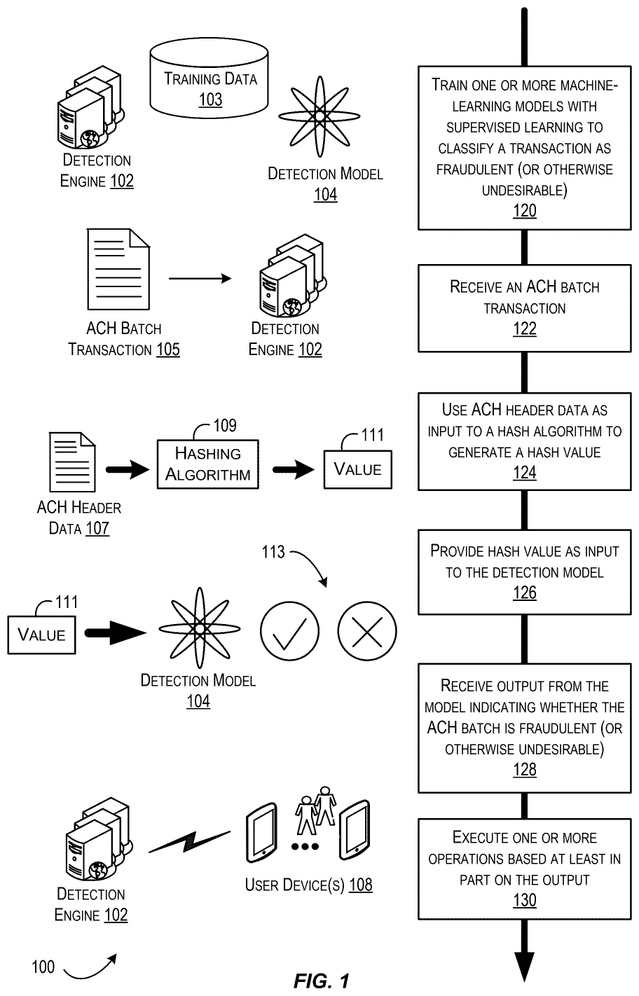

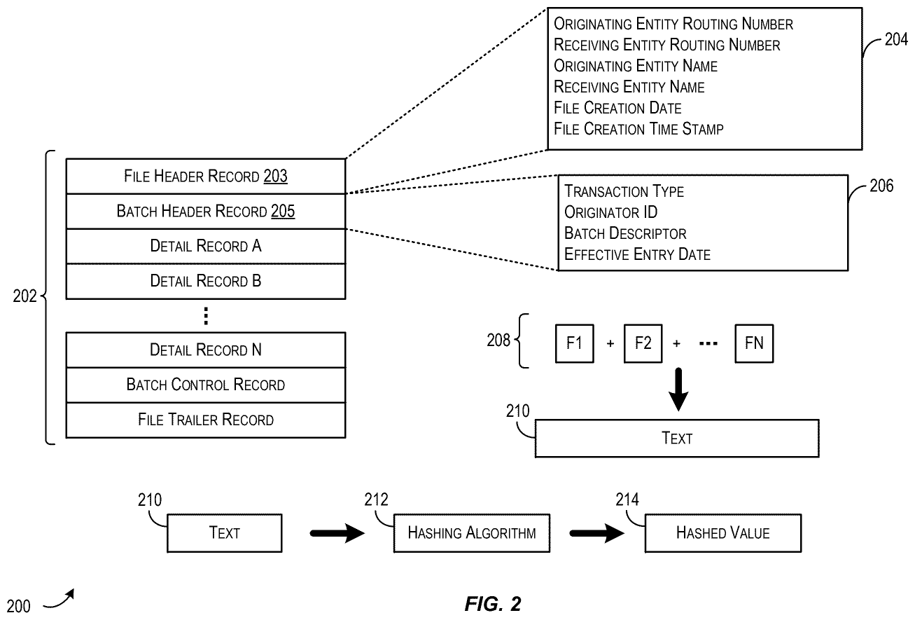

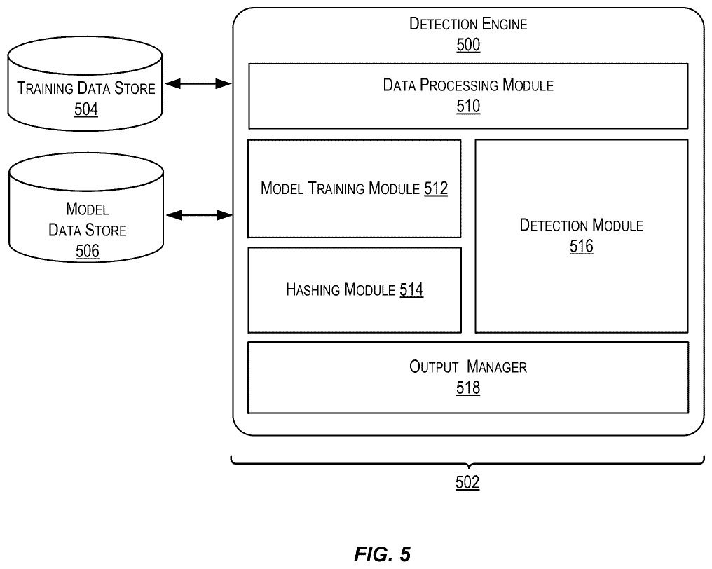

Moving on to FIG. 1 which illustrates an example flow for detecting fraudulent, or otherwise undesirable transactions with respect to automated clearing house (ACH) batches, in accordance with at least one embodiment. The operations discussed in connection with FIG. 1 may be performed with a detection engine 102 (hereinafter “DE 102”) which may be the same as and/or include some and/or all components, modules, methods, processes, steps, and/or procedures of FIG. 2-6 (e.g., detection engine 500 of FIG. 5). In some embodiments, DE 102 may be implemented by one or more computer(s), as a service, within an application, or the like. The operations discussed in connection with FIG. 1 may be performed in any suitable order. More or fewer operations than those depicted in FIG. 1 may be employed without diverting from this disclosure.

In some embodiments, at block 120 one or more machine-learning model(s) (e.g., detection model 104) may be trained according to any suitable supervised learning algorithm to determine whether a transaction corresponding to the input is fraudulent (or otherwise undesirable). For example, a detection engine 102 (e.g., software, firmware, hardware, etc.) may access training data 103, a data store configured to store a training data set. The training data 103 may include any suitable number of fraudulent and/or legitimate ACH batch transaction examples. Each example may include a hash value generated using a hashing algorithm with any suitable combination of the corresponding ACH batch header data fields provided as input and a label indicating that the example is fraudulent or legitimate.

In some examples, the training data 103 may include historically determined fraudulent and/or legitimate batch transactions and/or manually labeled fraudulent and/or legitimate batch transactions. As another example, the training data 103 may be labeled differently such as desirable and undesirable. In some embodiments, a user may create one or more fraudulent (or otherwise undesirable) ACH batch transactions that include incorrect entry dates, false company records, fake bank names, fake ACH details, etc. that may facilitate improving detection and classification of similar fraudulent transactions by the detection model 104. Similarly, the user may create one or more legitimate (or otherwise desirable) ACH batch transactions using legitimate bank names, routing numbers, and the like. Each of these user-created ACH batch header data instances may be hashed and labeled with a label indicating that the example is fraudulent or legitimate. Additionally, or alternatively, a user may label hash values corresponding to historical ACH batch header data instances that were historically deemed to be fraudulent or legitimate (or undesirable/desirable) with a label indicating the same.

The training data 103 may be used with any suitable supervised learning algorithm to train the detection model 104 to identify a new ACH batch header as either fraudulent or legitimate (or undesirable/desirable). A method for training the detection model 104 is discussed in more detail with respect to FIG. 2 and is not repeated here, for brevity.

At block 122, the detection engine 102 may receive one or more ACH batch transactions associated with an ACH network. In some embodiments, the detection engine 102 may operate as part of a receiving system that operates as part of the ACH network, the receiving system being configured to receive ACH batch transactions. The ACH batch transaction 105 may include one or more batches with each batch including one or more individual transactions. In some embodiments, the individual transactions of a batch may share a common data field (e.g., a standard entry class (SEC) code, an effective entry date, a company identifier, etc.), although not necessarily so. In addition, in some non-limiting examples, specific batch transactions may be selected for detection analysis based at least in part on a predefined protocol and ACH header data. For example, in some embodiments, batches having batch header data values that include descriptors indicating a loan payment, a water bill payment, payroll, etc., may be selected for detection analysis according to the predefined protocol, while other batch transactions are excluded from the detection analysis. In some embodiments, all ACH batch transactions may be subjected to the detection analysis performed by the detection engine 102.

At block 124, the detection engine 102 may use ACH header data 107 as input to hashing algorithm 109 to generate a resultant value (e.g., value 111). To obtain ACH header data 107, the detection engine 102 may process the ACH batch transaction 105 to extract any set of suitable data field values (e.g., two or more of file header record(s), batch header record(s), entry detail record(s), file control record(s), file padding(s), etc.). In a non-limiting example, ACH header data 107 may include any suitable combination of one or more data field values selected from a file header record and/or a batch header record of the ACH batch transaction 105. Example data fields are discussed in more detail with respect to FIG. 2. In some embodiments, the set of data field values may be combined according to a specified order (e.g., user defined, pre-defined preferences, common fields, etc.) to form ACH header data 107 prior to being hashed. In some embodiments, the ACH header data 107 is a string generated based at least in part on combining the set of data field values according to the specified order.

In some embodiments, the detection engine 102 may generate a hash value based, at least in part, on providing the ACH header data 107 to a hashing algorithm as input. The hashing algorithm may function to generate a fixed length value for the hash value. In some examples, the hashing algorithm may include one or more hashing algorithms such as 256-bit secure hashing algorithms “SHA” or any suitable hashing algorithm that may convert data values into hash values or otherwise generate a hash value from data provided as input. In a non-limiting example, the hash value may include concatenating the set of data field values of the one or more batch transaction header(s) to form a text string (e.g., a series of letters, numbers, etc.). The text string (e.g., “bluebankdebitaccount2319158182”) may include any suitable combination of data field values of the file and/or batch header of ACH batch transaction 105. The text string may be provided to the hashing algorithm as input to produce a hash value (e.g., a text string of “bluebankdebitaccount2319158182” becomes “42163a9a4c0f8b841f55294835eaa8d41cc850ee” using SHA hash).

At block 126, the detection engine 102 may provide the hash value obtained at block 124 (e.g., value 111) to the detection model 104 as input. In response, the detection model 104 may determine a likelihood that an ACH batch transaction corresponding to the hash value is fraudulent (or otherwise undesirable). The detection model 104 may utilize patterns and relationships between hash values and the fraudulent/legitimate designation (or undesirable/desirable designation) learned during its training phase, to generate an output.

At block 128, the detection engine 102 may receive the output from the detection model 104. In an example, the detection model 104 may output a likelihood (e.g., probability score such as 50%, 60%, 70%, etc.) that the ACH header data 107 belongs to a fraudulent (or otherwise undesirable) ACH batch transaction. If the value 111 (e.g., the hash value corresponding to ACH header data 107) is determined by the model to be fraudulent/undesirable (e.g., the model outputs a likelihood value that breaches a predefined threshold), the ACH batch transaction 105 corresponding to ACH header data 107 and value 111 may be deemed fraudulent/undesirable.

At block 130, the detection engine 102 may execute one or more operations based at least in part on the output from the detection model 104. For example. If the detection model 104 determines that an ACH batch transaction initiated from CompanyXYZ appears to be fraudulent/undesirable, the detection engine 102 may reject the CompanyXYZ. Additionally, or alternatively, the detection engine 102 may notify one or more user device(s) 108 (e.g., smartphones, computers, email(s), etc.) of the likelihood of fraudulent/undesirable activity associated with Company XYZ. Notifying the one or more user device(s) may include, but should not be limited to, any suitable notification such as a short-message-service (SMS) notification, an automated phone call, an acknowledgement, a summary/report of the fraudulent activity, and/or a request for action from a user associated with a specific user device. In some embodiments, the detection engine 102 may request confirmation of receipt of the notification, and/or request one or more user interaction(s) such as, but not limited to, rejecting the batch transaction, allowing the batch transaction to proceed, confirming the batch transaction is fraudulent/undesirable, confirming the batch transaction is non-fraudulent/desirable, or the like. In some embodiments, user confirmations(s) can be used by the detection engine 102 to provide a feedback loop to the detection model 104. For example, if a number of users are notified of a high likelihood of fraudulent/undesirable activity associated with the ACH header data 107 and ACH batch transaction 105 and at least a threshold number (e.g., more than eighty percent) of the users confirm that the ACH batch transaction 105 is legitimate, a new training data example may be generated using the value 111 (e.g., the hash value generated by the hashing algorithm 109 from ACH header data 107) and a label indicating that value 111 is associated with a legitimate/desirable ACH batch transaction. This new example may be used to retrain or update the detection model 104 at any suitable time.

FIG. 2 is an example block diagram 200 illustrating techniques for generating a hash value from Automated Clearing House (ACH) header data, in accordance with at least one embodiment. The techniques may be utilized by detection engine 102 of FIG. 1 and/or, at least partially by a computing component separate and distinct from the detection engine 102.

In some embodiments, example ACH batch transaction 202 may include a variety of records including a file header record 203 which may include a number of fields such as file header record data fields 204. In some embodiments, file header record data fields 204 may include any suitable combination of an originating entity routing number, a receiving entity routing number, an originating entity name, a receiving entity name, a file creation date, a file creation time stamp, or the like. In general, the file header 202 includes any suitable number of fields and/or records to accurately represent all parties of interest for transactions of interest. The ACH batch transaction 202 may include other header records such as a batch header record 205 which may include batch header data fields 206. Batch header data fields 206 may include any suitable combination of a transaction type, an originator identifier (ID), a batch descriptor, an effective entry date, or the like.

In some embodiments, multiple fields from multiple header records may be utilized by a detection engine (e.g., the detection engine 102 of FIG. 1). For example, a set of batch transaction headers (e.g., file header record 203, batch header record 205, etc.) from batch transaction instances (e.g., ACH batch transaction 202) may be provided to a hashing algorithm (e.g., such as the hashing algorithm of FIG. 1). Any suitable combination of the file header record data fields 204 and/or the batch header data fields 206, represented in FIG. 2 by data fields 208, may be combined to form a text string 210. By way of example, the originating entity routing number, originating entity name, and batch descriptor corresponding to the ACH batch transaction 202 may be combined to form text string 210. Text string 210 may be provided to the hashing algorithm 212 (an example of hashing algorithm 109 of FIG. 1) to produce a corresponding hash value (e.g., hash value 214, an example of value 111 of FIG. 1). In a non-limiting example in which the originating entity routing number is “123152522”, the originating entity name is, “CompanyXYZ”, the batch descriptor is “loan payment”, each of these data field values may be combined into text string 210 (e.g., “123152522CompanyXYZloanpayment”, “123152522 CompanyXYZ loan payment”, etc.). While three fields have been demonstrated in this non-limiting example, any suitable number of fields may be used to generate text string 210. In addition, while header specific fields were chosen in this non-limiting example, higher taxonomic fields (e.g., file header record, batch header record, detail record A, etc.) may be used alone, or in conjunction with any other suitable field. In some embodiments, a predefined protocol may be utilized to identify an order by which the data field values are combined to form text string 210.

In some embodiments, the text string 210 (e.g., 123152522CompanyXYZloanpayment) may be provided to a hashing algorithm 212 to produce hash value 214. For example, the text string 10 of, “123152522Company XYZloanpayment” may produce a hash value 214 of “751c5e8aff46dc0108eabbdddd387889887edcfe”. This hash value may then be provided as input to the detection model 104 (e.g., machine learning model). The output of the detection model 104 may indicate that the hash value corresponds to a fraudulent or legitimate transaction.

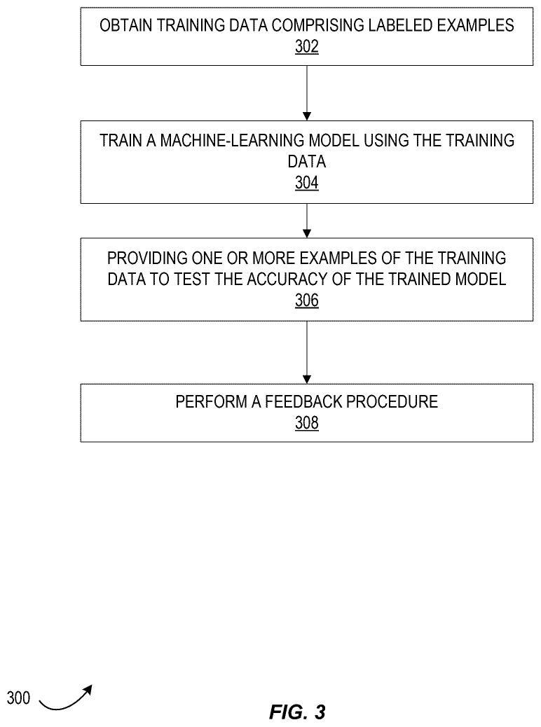

FIG. 3 illustrates a flow for an example method 300 for training a machine-learning model (e.g., the detection model 104 of FIG. 1), in accordance with at least one embodiment. The method 300 may be performed by the detection engine (DE) 102 of FIG. 1 and/or, at least partially, by a computing component separate and distinct from the DE 101.

The method 300 may begin at 302, where training data comprising labeled examples may be obtained. The training data may include any suitable number of positive (e.g., fraudulent, undesirable, anomalous, etc.) or negative (e.g., legitimate, desirable, not anomalous, etc.) examples. Each example may include a hash value that has been generated from an ACH batch header in the manner described above in connection with FIG. 2 and a label that indicates that the example is either fraudulent/undesirable/anomalous or legitimate/desirable/not anomalous.

At 304, a machine-learning model (e.g., the detection model 104 of FIG. 1) may be trained using the training data and any suitable supervised machine-learning algorithm. A supervised machine-learning algorithm may learn patterns and relationships from the labeled training data set. As the training data is processed, a function is built that maps new input data to expected output values. The model may be trained until it can detect these patterns/relationships between input data and output labels, such that it can yield accurate labeling results when presented with new inputs. Example supervised machine-learning algorithms may include, but are not limited to, linear regression (an algorithm used to find a linear relationship between a dependent variable and one or more independent variables), logistic regression (an algorithm used to predict a binary outcome based on one or more independent variables), support vector machines (an algorithm used to find a best line or hyperplane that separates data points in a data set), decision trees (an algorithm that is used to create a model of decisions based on data), Naive Bayes (an algorithm used to predict the probability of an event based on prior knowledge), K-Nearest Neighbors (an algorithm used to find the K nearest neighbors of a data point), neural networks (an algorithm used to create a model that can learn and make predictions), random forests (an algorithm used to create a model that can learn and make predictions), and the like. In some embodiments, only a portion (e.g., 80%, 90%, etc.) of the training data set may be used to train the machine-learning model.

At 306, any suitable portion of the training data set (e.g., 20%, 10%) may be utilized to test the accuracy of the model. In some embodiments, one or more training data set examples may be provided to the trained model to produce one or more outputs. These outputs (e.g., labels of “fraudulent” or “legitimate,” “undesirable” or “desirable,” “anomalous” or “not anomalous,” etc.) may be compared to the labels already known for these examples to calculate how accurate the trained model is at correctly identifying hash values generated from ACH headers as being fraudulent or legitimate. In some embodiments, the machine-learning model may be trained but not utilized until the accuracy identified for the model breaches a predefined threshold (e.g., 80% accurate, 90% accurate, etc.).

At 308, a feedback procedure may be performed. By way of example, as the trained machine-learning model is utilized for subsequent inputs, the subsequent output generated by the model may be added to corresponding input and used to retrain and/or update the machine-learning model. In some embodiments, the example may not be used to retrain or update the model until a feedback procedure is executed. In some embodiments, the feedback procedure may include presenting any suitable portion of an ACH header fields and corresponding values, the hash value generated based on that ACH header, and the output generated by the machine-learning model to a user via a user interface. The user may utilize the interface to indicate whether the output produced by the machine-learning model is correct for the given example. The input provided during the feedback procedure, either indicating the output was accurate or inaccurate, can be added to the training data and/or used to retrain and/or update the machine-learning model at any suitable time.

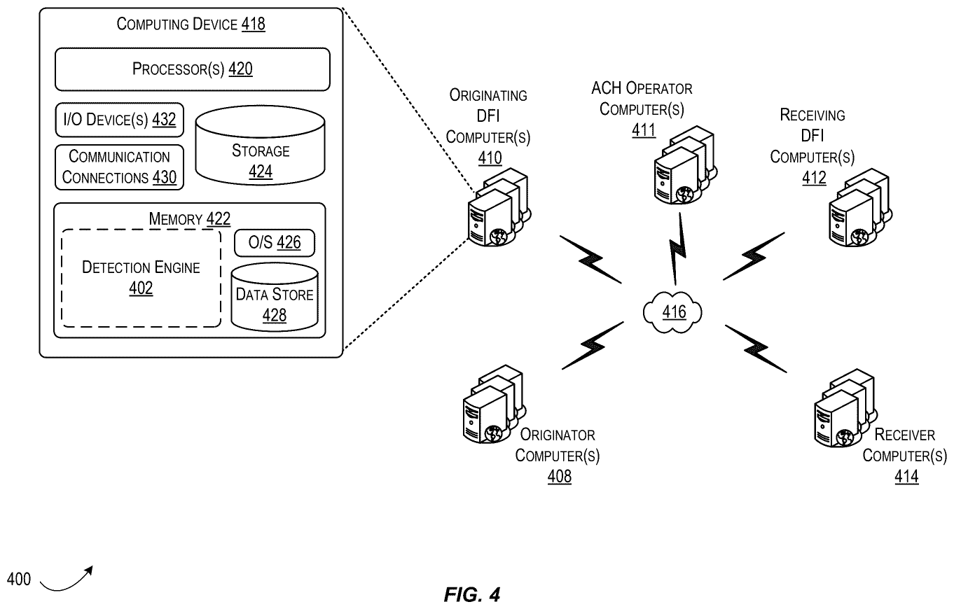

FIG. 4 is a block diagram illustrating an example system 400 including a detection engine 402, in accordance with at least one embodiment. System 400 is an example of an Automated Clearing House (ACH) in which a variety of computing devices may interact to provide a batch-oriented electronic funds transfer system that provides clearing and settling of electronic payments. In some embodiments, the ACH is governed by the Nacha Operating Rules, which specify how funds are disbursed and settled among financial institutions. The system 400 may be used for a variety of transfers, including but not limited to, direct deposit of paychecks, pension disbursements, travel reimbursements, monthly debits for routine payments such as a mortgage payment, tax refunds, social security payments, and the like. The system 400 may be a batch process, store-and-forward system that provides value-dated settlement transaction for credits and debits via push and/or pull transactions.

Originator computer(s) 408 may be operated on behalf of an originator (e.g., a business, a consumer, or another entity) that initiates ACH transactions. An ACH transaction may include any suitable number of batch transactions. Each batch transaction may include any suitable number of ACH credits and/or debits. As a non-limiting example, a payroll, including a batch of 100 ACH credits corresponding to 100 employee paychecks, may be initiated from originator computer(s) 408 and transmitted to Originating Depository Funding Institution (ODFI) Computer(s) 410.

In some embodiments, ODFI Computer(s) 410 may be a financial institution participating in the ACH that is configured to receive payment instructions from Originator Computer(s) 408. Once received, ODFI Computer(s) 410 may forward the ACH transaction(s) to ACH Operator(s) 411. ACH Operator(s) 411 may be one or more central clearing facilities that receives ACH transactions from various ODFI Computer(s) 410 (corresponding to various participating financial institutions) and forwards those ACH transaction to Receiving Depository Financial Institution (RDFI) Computer(s) 412. ACH Operator(s) 411 may be further configured to perform settlement functions for the participating financial institutions. RDFI Computer(s) 412 may be operated on behalf of another financial institution and configured to receive ACH transactions from the ACH Operator(s) 411. In some embodiments, the RDFI Computer(s) 412 may be configured to post the ACH credits and/or debits of the ACH batch to respective accounts of a set of receivers. Receiver Computer(s) 414 may be operator on behalf of a consumer, corporation, or entity that has previously authorized the originator associated with the Originator Computer(s) 408 to initiate an ACH push or ACH pull, to or from the receiver's account with the receiving depository financial institution. The receiver may view the balance of their account via the Receiver Computer(s) 414 using any suitable web browser or application managed by the RDFI Computer(s) 412.

In some embodiments, the Originator Computer(s) 408, the ODFI Computer(s) 410, the ACH Operator(s) 411, the RDFI Computer(s) 412, and the Receiver Computer(s) 414 may be configured to communicate via network 416. Network 416 may include any suitable combination of many different types of networks, such as cable networks, the Internet, wireless networks, cellular networks, and other private and/or public networks.

The Originator Computer(s) 408, the ODFI Computer(s) 410, the ACH Operator(s) 411, the RDFI Computer(s) 412, and the Receiver Computer(s) 414 may each be an example of the computing device 418. In some embodiments, the computing device 418 may include one or more processors (e.g., processor(s) 420). The processor(s) 420 may be implemented in hardware, computer-executable instructions, firmware, or combinations thereof. Computer-executable instruction or firmware implementations of the processor(s) 420 may include computer-executable or machine-executable instructions written in any suitable programming language.

Computing device 418 may include memory 422. The memory 422 may store computer-executable instructions that are loadable and executable by the processor(s) 420, as well as data generated during the execution of these programs. The memory 422 may be volatile (such as RAM) and/or non-volatile (such as ROM, flash memory, etc.). The computing device 418 may include additional storage (e.g., storage 424), which may include removable storage and/or non-removable storage. Storage 424 may include, but is not limited to, magnetic storage, optical disks and/or tape storage. The disk drives and their associated computer-readable media may provide non-volatile storage of computer-readable instructions, data structures, program modules, and other data for the computing devices.

The memory 422 and/or storage 424 may be examples of computer-readable storage media. Computer-readable storage media may include volatile, or non-volatile, removable, or non-removable media implemented in any method or technology for storage of information such as computer-readable instructions, data structures, program modules, or other data. In some embodiments, memory 422 and the storage 424 are examples of computer storage media. Memory 422 and/or additional storage 424 may include, but are not limited to, any suitable combination of PRAM, SRAM, DRAM, RAM, ROM, EEPROM, flash memory or other memory technology, CD-ROM, DVD, magnetic tape, magnetic disk storage or other magnetic storage devices, or any other medium which can be used to store desired information, and which can be accessed by the computing device 418. Computer-readable media may include computer-readable instructions, program modules, or other data transmitted within a data signal, such as a carrier wave, or other transmission. However, as used herein, computer-readable storage media does not include computer-readable communication media.

The memory 422 may include an operating system 426 and one or more data stores 428, and/or one or more application programs, modules, or services. The computing device may also contain communications connection(s) 430 that allow the computing device 418 to communicate with a stored database, another computing device, a server, user terminals and/or other devices (e.g., via one or more networks, not depicted). The computing device may also include I/O device(s) 432, such as a keyboard, a mouse, a pen, a voice input device, a touch input device, a display, speakers, a printer, etc.

In some embodiments, the memory 422 may store instructions that, when executed by processor(s) 420 implement the functionality described herein with respect to the detection engine 402 (e.g., the detection engine 102 of FIG. 1). By way of example, ODFI Computer(s) 410 may execute the instructions for detection engine 102 to provide the functionality described above in connection with FIGS. 1-3. In some embodiments, the detection engine 402 may execute on any suitable computer depicted in FIG. 4.

FIG. 5 is a schematic diagram of an example computer architecture for the detection engine 500, including a plurality of modules that may perform functions in accordance with at least one embodiment. Detection engine 500 may be executed by any suitable component of the fraud detection system 400 of FIG. 4 (e.g., the ODFI computer(s) 410, the RDFI computer(s) 412, the ACH operator(s) 411, etc.). The detection engine 500 may support processes, methods, operations, and techniques described above with respect to FIGS. 1-3 and 6. The modules 502 may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 502 may be execute as part of the detection engine 500, or the modules 502 may exist as separate modules or services external to the detection engine 500. In some embodiments, the modules 502 may be executed by the same or different computing devices, as a service, as an application, or the like.

In the embodiment shown in the FIG. 5, data stores such as training data store 504 and model data store 506 are shown, although data can be maintained, derived, or otherwise accessed from various data stores (e.g., data store 428), either remote or local to the detection engine 500, to achieve the functions described herein. The detection engine 500, as shown in FIG. 5, includes various modules such as a data processing module 510, model training module 512, hashing module 514, detection module 516, and output manager 518. Some functions of the modules 510, 512, 514, 516, and 518 are described below. However, for the benefit of the reader, a brief, non-limiting description of each of the modules is provided in the following paragraphs.

Data processing module 510 may include any suitable processing components (e.g., software, hardware, firmware, etc.) operable to support functions, operations, communications, etc. between one or more of modules 512, 514, 516, and 518 and data stores 504, 506. The data processing module 510 may function to transmit, receive, and/or otherwise communicate with ACH networks over one or more communication networks (e.g., the Internet, wide area networks “WAN”, local area networks “LAN”, etc.). While not depicted, the data processing module 510 need not be physically local to the detection engine 500, and may function, at least in part, as a component of a larger network (e.g., cloud network or similar). The data processing module 510 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). The data processing module 510 any suitable number of programs, algorithms, computer readable instructions, that, when executed, store, retrieve, and/or transmit such data according to a predetermined periodicity, schedule (e.g., every microsecond, every hour, every day, etc.), frequency, or by request (e.g., user request). In some embodiments, the data processing module 510 may be configured to receive an Automated Clearing House (ACH) batch transaction.

The model training module 512 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). Model training module 512 may include any suitable number of programs, algorithms, computer readable instructions, that, when executed, train a machine-learning model (e.g., the detection model 104 of FIG. 1). In some embodiments, the machine-learning model may be trained utilizing method 300 of FIG. 3. The model training module 512 may store and/or retrieve a training data set (e.g., training set 103 of FIG. 1) from training data store(s) 504. For example, the model training module 512 may retrieve a set of hash values from the training data store(s) 504, each hash value being labeled as corresponding to a legitimate or fraudulent batch transaction. An example of a set of hash values for legitimate batch transaction(s) may include batch transactions from a known and reliable bank or network of banks. An example for fraudulent batch transactions may include batch transactions that were historically found to have been fraudulent after-the-fact such as batch transactions from a company convicted of financial crimes. The model training module 512 may obtain one or more relevant algorithms for supervised training (e.g., algorithms as in FIG. 3). Additionally, the model training module 512 may function to periodically check the training data store 504 and/or the model data store 506 for updates to historical data, current data, algorithm updates, or similar. The model training module 512 may be configured to store, retrieve, or transmit such data according to a predetermined periodicity, schedule (e.g., every hour, every day, etc.), frequency, or by request (e.g., user request). The model training module 512 may be configured to store any suitable data corresponding to the trained model within model data store 506.

The hashing module 514 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). Hashing module 514 may include any suitable number of programs, algorithms, computer readable instructions, that, when executed, hash a text string provided as input (e.g., any string that includes numbers, letters, or ASCII symbols). The hashing module 514 may utilize one or more types of hashing algorithms. In some examples, the hashing module 514 may choose one type of hashing algorithm for a certain situation and another type of hashing algorithm for another situation. For example, the hashing module 514 may choose a hashing algorithm which prioritizes performance such as message digest 5 “MD5” which produces a 128-bit hash value output or may choose an algorithm which has higher performance requirements but provides more information such as secure hashing algorithm “SHA256” which provides a 256-bit hash value output. While these two algorithms have been illustrated in this discussion, any suitable hashing algorithm may be implemented according to the requirements and/or preferences of model training module 512 and detection module 516. The hashing module 514 may be configured to store, retrieve, or transmit such data according to a predetermined periodicity, schedule (e.g., every hour, every day, etc.), frequency, or by request (e.g., user request). In some embodiments, the functionality of the hashing module 514 may be invoked by the data processing module 510 in response to receiving an ACH batch transaction (e.g., ACH batch transaction 105 of FIG. 1, an example of the ACH batch transaction 202.

The detection module 516 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). Detection module 516 may include any suitable number of programs, algorithms, computer readable instructions, that, when executed, detect fraudulent activity in ACH batch transactions (e.g., ACH batch transaction 105 in FIG. 1). The detection module 516 may receive the hash values from the hashing module 514. The detection module 516 may obtain the detection model (e.g., detection model 104 of FIG. 1) from model data store 506. The detection module 516 may provide the received hash value as input to the model. The detection module 516 may be configured to receive output from the model indicating a likelihood that the hash value corresponds to a fraudulent ACH batch transaction. In some embodiments, the detection module 516 may be configured to communicate with output manager 518 based at least in part on the output received from the model. In some embodiments, detection module 516 may provide the hash value and corresponding output provided by the model to the model training module 512. The model training module 512 may perform a feedback procedure as discussed in connection with FIG. 3 to confirm that the output provided by the model is accurate. If so, the model training module 512 may be configured to store the hash value and its corresponding output as a new training data example in training data store 504. The new training data example may be used by the model training module 512 at any suitable time to train a new model and/or retrain the model stored in model data store 506.

The output manager 518 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). Output Manager 518 may include any suitable number of programs, algorithms, computer readable instructions, or similar to control, interact, provide feedback, provide alerts, provide notifications, and/or operations in response to the detection module 516 determining that information in ACH header data (e.g., such as ACH header data 107 of FIG. 1) indicates a fraudulent or legitimate ACH batch transaction. The output manager 518 may include functionality to communicate with one or more user device(s) (e.g., such as user device(s) 108 of FIG. 1 via communication connections 430 of FIG. 4). The operation(s) may include aggregated information from modules 510, 512, 514, 516 and data stores 504, 506. For example, the operation(s) may include transmitting a notification to one or more user device(s) 108 that indicates that the detection model has determined that there is a seventy percent likelihood that a particular ACH batch transaction is be fraudulent. In some embodiments, the notification may include information such as ACH header data In some embodiments, the output manager 518 may be configured to reject the ACH transaction based at least in part on a determination that the ACH transaction is fraudulent based on the hash value corresponding to the ACH header data for that ACH transaction The output manager 518 may be configured to store, retrieve, or transmit such data according to a predetermined periodicity, schedule (e.g., every hour, every day, etc.), frequency, or by request (e.g., user request).

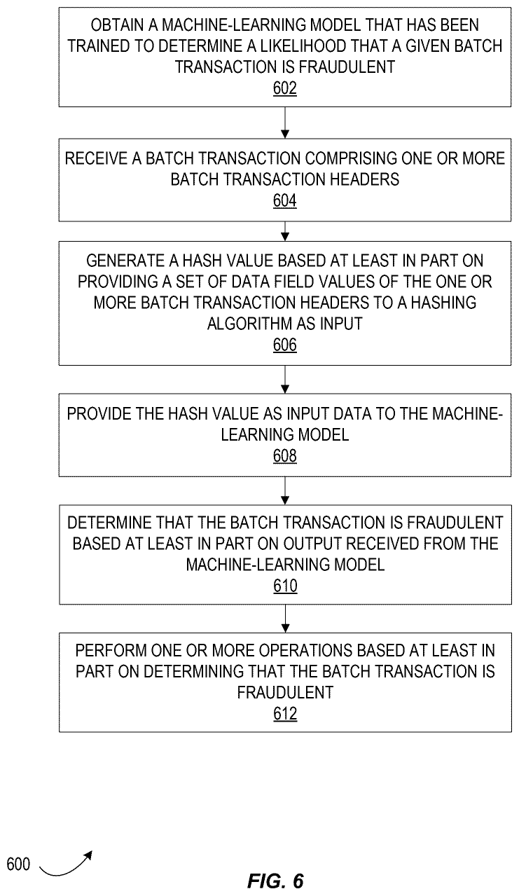

FIG. 6 is a block diagram illustrating an example method 600 for determining a batch transaction is fraudulent, in accordance with at least one embodiment. A non-transitory computer-readable storage medium may store computer-executable instructions that, when executed by at least one processor, cause at least one computer to perform instructions comprising the operations of the method 600. It should be appreciated that the operations of the method 600 may be performed in any suitable order, not necessarily the order depicted in FIG. 6. Further, the method 600 may include additional, or fewer operations than those depicted in FIG. 6. The operations of method 600 may be performed by any suitable portion of the detection engine 402 of FIG. 4 and/or detection engine 500 of FIG. 5 which may include one or more computing devices such as computing device 418 of FIG. 4.

The method 600 may begin at 602, where a machine-learning model (e.g., detection model 104 of FIG. 1) may be obtained. The machine-learning model may be previously trained (e.g., using method 300 of FIG. 3) to determine a likelihood that a given ACH batch transaction is fraudulent based at least in part on a hash value generated from providing ACH header data fields corresponding to the ACH batch transaction to a hashing algorithm as input.

At step 604, a batch transaction may be received that includes one or more batch transaction headers (e.g., file header record 203 and/or batch header record 205 of FIG. 2, corresponding to a single batch transaction). In some examples, the ACH batch transaction may be received from one or more networks such as an Automated Clearing House (ACH) network, bank network, or similar. In some embodiments, a single ACH batch transaction may comprise multiple batch transactions, each of the batch transactions having a corresponding set of header records (e.g., an instance of file header record 203 and/or batch header record 205). The detection engine may extract the set of one or more headers corresponding to each batch transaction included in the ACH batch transaction. The operations performed at 606-610 may be performed for each set of headers.

At step 606, a hash value may be generated (e.g., by the hashing module 514 of FIG. 5) based at least in part on providing a set of data field values of the one or more batch transaction headers to a hashing algorithm (e.g., hashing algorithm 212 of FIG. 2) as input. The detection engine may include any number of hashing algorithms that are suitable to hash the one or more batch transaction headers based on performance requirements, memory limitations, processing speed preferences, or similar. In addition, the detection engine may store, retrieve, and/or update data stores (e.g., such as data stores 504, 506 of FIG. 5) with the hash values determined for the one or more transaction headers.

At step 608, the detection engine may provide the hash value as input data to the machine-learning model (e.g., the detection model 104 of FIG. 1 and/or the machine-learning model of FIG. 3).

At step 610, the detection engine may determine that the batch transaction is fraudulent based at least in part on output received from the machine-learning model. By way of example, a predefined threshold (e.g., 80%) may be utilized. When the output provided by the model breaches the predefined threshold (e.g., is 80% or higher), the ACH transaction corresponding to the hash value of the header data provided to the model may be deemed to be fraudulent. If the output provided by the model fails to breach the predefined threshold, the ACH transaction may be deemed legitimate.

At step 612, the detection engine may perform one or more operations based at least in part on determining that the batch transaction is fraudulent. For example, the detection engine may reject the ACH transaction and/or may transmit a notification to one or more user devices (e.g., such as user device(s) 108 of FIG. 1) that the batch transaction was identified as being fraudulent. In some embodiments, the notification may include information such as ACH header information.

Although not depicted, the detection engine may perform a different set of operations based at least in part on determining that the batch transaction is legitimate. For example, the detection engine may allow the ACH transaction to proceed. In some embodiments, output provided by the model may be confirmed (e.g., by a user at a subsequent time). Output which has been confirmed to be accurate, along with the hash value of the header data fields may be stored as a new training data example and used to train, retrain, or update a machine-learning model at any suitable time.

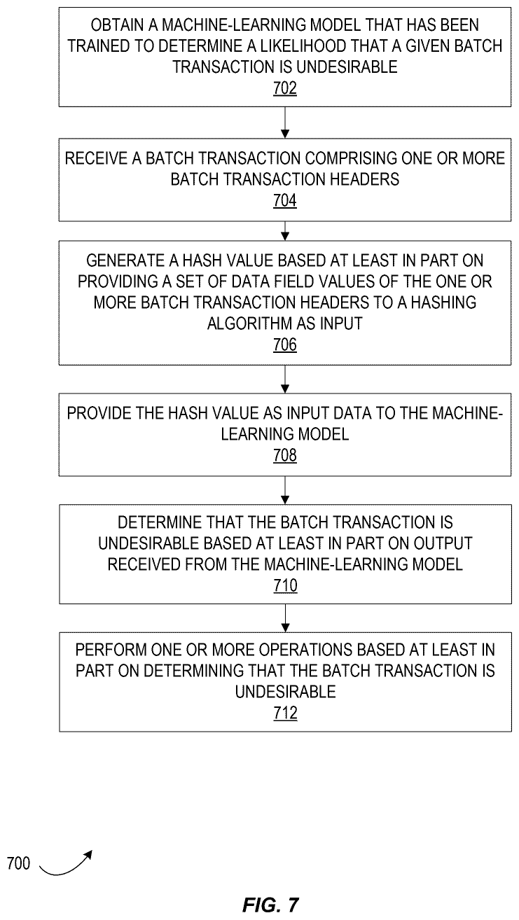

FIG. 7 is a block diagram illustrating an example method 700 for determining that a batch transaction is undesirable (and/or anomalous), in accordance with at least one embodiment. A non-transitory computer-readable storage medium may store computer-executable instructions that, when executed by at least one processor, cause at least one computer to perform instructions comprising the operations of the method 700. It should be appreciated that the operations of the method 700 may be performed in any suitable order, not necessarily the order depicted in FIG. 7. Further, the method 700 may include additional, or fewer operations than those depicted in FIG. 7. The operations of method 700 may be performed by any suitable portion of the detection engine 402 of FIG. 4 and/or detection engine 500 of FIG. 5 which may include one or more computing devices such as computing device 418 of FIG. 4.

The method 700 may begin at 702, where a machine-learning model (e.g., detection model 104 of FIG. 1) may be obtained. The machine-learning model may be previously trained (e.g., using method 300 of FIG. 3) to determine a likelihood that a given ACH batch transaction is undesirable (and/or anomalous) based at least in part on a hash value generated from providing ACH header data fields corresponding to the ACH batch transaction to a hashing algorithm as input.

At step 704, a batch transaction may be received that includes one or more batch transaction headers (e.g., file header record 203 and/or batch header record 205 of FIG. 2, corresponding to a single batch transaction). In some examples, the ACH batch transaction may be received from one or more networks such as an Automated Clearing House (ACH) network, bank network, or similar. In some embodiments, a single ACH batch transaction may comprise multiple batch transactions, each of the batch transactions having a corresponding set of header records (e.g., an instance of file header record 203 and/or batch header record 205). The detection engine may extract the set of one or more headers corresponding to each batch transaction included in the ACH batch transaction. The operations performed at 706-710 may be performed for each set of headers.

At step 706, a hash value may be generated (e.g., by the hashing module 514 of FIG. 5) based at least in part on providing a set of data field values of the one or more batch transaction headers to a hashing algorithm (e.g., hashing algorithm 212 of FIG. 2) as input. The detection engine may include any number of hashing algorithms that are suitable to hash the one or more batch transaction headers based on performance requirements, memory limitations, processing speed preferences, or similar. In addition, the detection engine may store, retrieve, and/or update data stores (e.g., such as data stores 504, 506 of FIG. 5) with the hash values determined for the one or more transaction headers.

At step 708, the detection engine may provide the hash value as input data to the machine-learning model (e.g., the detection model 104 of FIG. 1 and/or the machine-learning model of FIG. 3).

At step 710, the detection engine may determine that the batch transaction is undesirable (and/or anomalous) based at least in part on output received from the machine-learning model. By way of example, a predefined threshold (e.g., 80%) may be utilized. When the output provided by the model breaches the predefined threshold (e.g., is 80% or higher), the ACH transaction corresponding to the hash value of the header data provided to the model may be deemed to be undesirable (and/or anomalous). If the output provided by the model fails to breach the predefined threshold, the ACH transaction may be deemed desirable (and/or not anomalous).

At step 712, the detection engine may perform one or more operations based at least in part on determining that the batch transaction is undesirable (and/or anomalous). For example, the detection engine may reject the ACH transaction and/or may transmit a notification to one or more user devices (e.g., such as user device(s) 108 of FIG. 1) that the batch transaction was identified as being undesirable. In some embodiments, the notification may include information such as ACH header information.

Although not depicted, the detection engine may perform a different set of operations based at least in part on determining that the batch transaction is desirable (and/or not anomalous). For example, the detection engine may allow the ACH transaction to proceed. In some embodiments, output provided by the model may be confirmed (e.g., by a user at a subsequent time). Output which has been confirmed to be accurate, along with the hash value of the header data fields may be stored as a new training data example and used to train, retrain, or update a machine-learning model at any suitable time.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random-access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Where terms are used without explicit definition as recited herein, it is understood that the ordinary meaning of the word is intended, unless a term carries a special meaning in the field of anomaly detection or other relevant fields. The terms “about” or “substantially”, “similar to”, “similar”, “approximately” are used to indicate a deviation from the stated property or numerical value within which the deviation has little to no influence of the corresponding function, property, or attribute of the structure being described. In an illustrated example, where a dimensional parameter is described as “substantially equal” to another dimensional parameter, the term “substantially” is intended to reflect that the two dimensions being compared can be unequal within a tolerable limit, such as a fabrication tolerance. In the present disclosure, “ranges” refers to a range of values between the two stated extents and/or including one of the two stated extents.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method for using a machine-learning model to detect fraud at a batch transaction level, comprising:
generating, by a computing device, a training data set by at least:
obtaining batch transaction instances that are known to be fraudulent or legitimate, wherein each batch transaction instance comprises a batch transaction header, one or more detail records, a batch control record, and a file trailer record;
generating a respective hash value from a respective batch transaction header of a respective batch transaction instance of the batch transaction instances, the respective hash value uniquely representing a respective set of data field values at a smaller size than a size corresponding to the respective set of data field values collectively; and
labeling the respective hash value for the respective batch transaction instance of the batch transaction instances with a respective label indicating that the respective batch transaction instance is fraudulent or legitimate;
training, by the computing device, the machine-learning model to detect fraudulent batch transactions, the machine-learning model being trained with a supervised learning algorithm and the training data set;
receiving, by the computing device, a received batch transaction instance comprising a plurality of received detail records for transactions that are to be processed as a unit and a received batch transaction header, the received batch transaction header comprising a plurality of data field values that correspond to each of the plurality of received detail records;
generating, by the computing device, a hash value that uniquely represents the plurality of data field values at a reduced size that is less than a collective size of the plurality of data field values of the received batch transaction header, the hash value being generated based at least in part on providing the plurality of data field values of the received batch transaction header to a hashing algorithm as input;
obtaining, by the computing device, output from the machine-learning model based at least in part on providing the hash value as input data to the machine-learning model;
detecting, by the computing device, fraud at a level corresponding to the received batch transaction instance based at least in part on output received from the machine-learning model; and
rejecting the received batch transaction instance comprising the plurality of detail records based at least in part on detecting the fraud at the level corresponding to the received batch transaction instance.

2. The computer-implemented method of claim 1, wherein the received batch transaction instance is associated with an automated clearing house network.

3. (canceled)

4. The computer-implemented method of claim 1, wherein generating the hash value comprises generating a text string by concatenating the plurality of data field values of the received batch transaction header, and wherein providing the plurality of data field values of the received batch transaction header to the hashing algorithm as the input comprises providing the text string to the hashing algorithm as the input.

5. The computer-implemented method of claim 1, wherein the plurality of data field values of the received batch transaction header corresponds to two or more data fields selected from a file header record and a batch header record of the received batch transaction instance.

6. The computer-implemented method of claim 1, wherein the plurality of data field values of the received batch transaction header comprises two or more data field values corresponding to an originating entity routing number, a receiving entity routing number, an originating entity name, a receiving entity name, a file creation date, a file creation time stamp, a transaction type, an originator identifier, a batch descriptor, or an effective entry date.

7. The computer-implemented method of claim 1, wherein the plurality of data field values of the received batch transaction header are combined according to a specified order prior to being provided to the hashing algorithm.

8. A computing device, comprising:
one or more processors; and
one or more memories storing computer-executable instructions for using a machine-learning model to detect fraud at a batch transaction level that, when executed by the one or more processors, causes the one or more processors to:
generate a training data set by at least:
obtain batch transaction instances that are known to be fraudulent or legitimate, wherein each batch transaction instance comprises a batch transaction header, one or more detail records, a batch control record, and a file trailer record;
generate a respective hash value from a respective batch transaction header of a respective batch transaction instance of the batch transaction instances, the respective hash value uniquely representing a respective set of data field values at a smaller size than a size corresponding to the respective set of data field values collectively; and
label the respective hash value for the respective batch transaction instance of the batch transaction instances with a respective label indicating that the respective batch transaction instance is fraudulent or legitimate;
train the machine-learning model to detect fraudulent batch transactions, the machine-learning model being trained with a supervised learning algorithm and the training data set;
receive a received batch transaction instance comprising a plurality of received detail records for transactions that are to be processed as a unit and a received batch transaction header, the received batch transaction header comprising a plurality of data field values that correspond to each of the plurality of received detail records;
generate a hash value that uniquely represents the plurality of data field values at a reduced size that is less than a collective size of the plurality of data field values of the received batch transaction header, the hash value being generated based at least in part on providing the plurality of data field values of the received batch transaction header to a hashing algorithm as input;
obtain output from the machine-learning model based at least in part on providing the hash value as input data to the machine-learning model;
detect fraud at a level corresponding to the received batch transaction instance based at least in part on the output received from the machine-learning model; and
reject the received batch transaction instance comprising the plurality of detail records based at least in part on detecting the fraud at the level corresponding to the received batch transaction instance.

9. The computing device of claim 8, wherein the received batch transaction instance is associated with an automated clearing house network.

10. (canceled)

11. The computing device of claim 8, wherein generating the hash value causes the one or more processors to generate a text string by concatenating the plurality of data field values of the received batch transaction header, and wherein executing the computer-executable instructions that provide the plurality of data field values of the received batch transaction header to the hashing algorithm as the input causes the one or more processors to provide the text string to the hashing algorithm as the input.

12. The computing device of claim 8, wherein the plurality of data field values of the received batch transaction header corresponds to two or more data fields selected from a file header record and a batch header record of the received batch transaction instance.

13. The computing device of claim 8, wherein the plurality of data field values of the received batch transaction header comprises two or more data field values corresponding to an originating entity routing number, a receiving entity routing number, an originating entity name, a receiving entity name, a file creation date, a file creation time stamp, a transaction type, an originator identifier, a batch descriptor, or an effective entry date.

14. The computing device of claim 8, wherein the plurality of data field values of the received batch transaction header are combined according to a specified order prior to being provided to the hashing algorithm.

15. A non-transitory computer-readable storage medium storing computer-executable instructions that, when executed with one or more processors of a computing device, causes the one or more processors to:
generate a training data set for a machine-learning model by at least:
obtain batch transaction instances that are known to be fraudulent or legitimate, wherein each batch transaction instance comprises a batch transaction header, one or more detail records, a batch control record, and a file trailer record;
generate a respective hash value from a respective batch transaction header of a respective batch transaction instance of the batch transaction instances, the respective hash value uniquely representing a respective set of data field values at a smaller size than a size corresponding to the respective set of data field values collectively; and
label the respective hash value for the respective batch transaction instance of the batch transaction instances with a respective label indicating that the respective batch transaction instance is fraudulent or legitimate;
train the machine-learning model to detect fraudulent batch transactions, the machine-learning model being trained with a supervised learning algorithm and the training data set;
receive a received batch transaction instance comprising a plurality of received detail records for transactions that are to be processed as a unit and a received batch transaction header, the received batch transaction header comprising a plurality of data field values that correspond to each of the plurality of received detail records;
generate a hash value that uniquely represents the plurality of data field values at a reduced size that is less than a collective size of the plurality of data field values of the received batch transaction header, the hash value being generated based at least in part on providing the plurality of data field values of the received batch transaction header to a hashing algorithm as input;
obtain output from the machine-learning model based at least in part on providing the hash value as input data to the machine-learning model;
detect fraud at a level corresponding to the received batch transaction instance based at least in part on the output received from the machine-learning model; and
reject the received batch transaction instance comprising the plurality of detail records based at least in part on detecting the fraud at the level corresponding to the received batch transaction instance.

16. The non-transitory computer-readable storage medium of claim 15, wherein the received batch transaction instance is associated with an automated clearing house network.

17. (canceled)

18. The non-transitory computer-readable storage medium of claim 15, wherein generating the hash value causes the one or more processors to generate a text string by concatenating the plurality of data field values of the received batch transaction header, and wherein executing the computer-executable instructions that provide the plurality of data field values of the received batch transaction header to the hashing algorithm as the input causes the one or more processors to provide the text string to the hashing algorithm as the input.

19. The non-transitory computer-readable storage medium of claim 15, wherein the plurality of data field values of the received batch transaction header corresponds to two or more data fields selected from a file header record and a batch header record of the received batch transaction instance.

20. The non-transitory computer-readable storage medium of claim 15, wherein the plurality of data field values of the received batch transaction header comprises two or more data field values corresponding to an originating entity routing number, a receiving entity routing number, an originating entity name, a receiving entity name, a file creation date, a file creation time stamp, a transaction type, an originator identifier, a batch descriptor, or an effective entry date.
